(19) United States
(12) Patent Application Publication
(10) Pub. No.: US 2007/0078688 A1
(43) Pub. Date: Apr. 5, 2007

(54) Personal information retrieval system

(76) Inventors: Charles A. Bischof, Santa Barbara, CA (US); Michael H. Healy, Santa Barbara, CA (US)

Correspondence Address: MARK RODGERS, 1590 SAN ROQUE ROAD, SANTA BARBARA, CA, 93105, US

(21) Appl. No.: 11/243,719

(22) Filed: Oct. 4, 2005

(51) Int. Cl. G06F 19/00; G06Q 40/00

(52) U.S. Cl. 705/3; 705/44

(57) ABSTRACT

The invention is a system allowing a person to carry with them a means for identifying themselves and enabling a service provider to access private data about the person. The invention is particularly suitable for the case of a person traveling who needs medical assistance. The novel system provides access for a service provider, who may be emergency medical personnel, to get access to medical history, medical data, and medical insurance information and the like. The system operates either by the person carrying a personal device which identifies him and enables communication with a database, or alternatively the personal device may contain the database information and be updated on a regular basis.

### RELATED APPLICATIONS

Not Applicable

### FEDERALLY SPONSORED RESEARCH

Not Applicable

### SEQUENCE LISTING

Not Applicable

### BACKGROUND OF THE INVENTION

This invention relates to a system for allowing a person, possibly traveling anywhere in the world, to provide service providers with access to extensive amounts of personal and private data, quickly and securely. The invention is particularly suitable to medical information but is applicable to other applications as well

With the advent of worldwide wireless communication, and portable processing/communications devices, such as wireless enabled laptop computers and PDA's as well as smart cell phones, along with the ability to accurately locate individuals using the GPS system, it has become possible to keep track of, and stay in communication with, individuals as they move about or travel. These capabilities have been exploited to provide freedom of movement to people with critical medical conditions. Several systems have been proposed which combine medical sensors carried by individuals, which when triggered by an emergency situation utilize a combination of wireless communication and positioning information to allow a timely response to the emergency. Such systems are described in U.S. Pat. No. 6,366,871, 5,752,976, and U.S. patent application Ser. No. 10/293,463, as well as other patents applications and publications. These disclosures are primarily aimed at people with known medical conditions or obvious need for monitoring, such as military personnel. These applications are characterized by medical sensors which trigger communications and location functions.

However, none of these systems address the need of healthy individuals who may require medical services when they travel away from home. As more individuals travel to take part in strenuous and potentially dangerous activities, such as white water kayaking, surfing, rock climbing, triathlons and other such pursuits, even extremely healthy individuals may have a high probability to need medical attention anywhere in the world. Moreover, otherwise healthy individuals may be taking medications, such as blood thinners or thyroid treatments, for example, which may react detrimentally with certain types of treatments. Thus such an individual may find themselves in a situation where their medical history, medical insurance information, and medical and responsible contact information may be of sudden vital importance.

Although systems exist for making medical history available over the Internet, such as the system available from OnFile Corporation, the Internet is unsatisfactory for many reasons. First, many parts of the world do not have Internet access, even at the Medical Institution level. Even where access is available, it is often slow, unreliable, and not secure. However, most parts of the world do have access to wireless communication.

Therefore it is an object of this invention to provide a secure, fast reliable, and convenient system for allowing a person to provide significant quantities of private data to service providers worldwide at any time. It is a further object of this invention to specifically provide the service when the information is medical or medical related and the service providers are medical personnel.

### BRIEF SUMMARY OF THE INVENTION

In one embodiment, the invention is a system for providing information about subscribers of an information service. The system includes a data base containing private information consensually provided by the subscribers, a physical identification device carried by a subscriber, identifying the subscriber, an information retrieval and display device, and at least one communication path between the data base and the retrieval and display device. Identification data from the identification device is presented to the retrieval and display device, causing the retrieval and display device to access the database through a communication path and retrieve information about the subscriber identified by the identification device.

In one version, the information includes at least one of medical data, medical history, medical insurance information, treatment authorization, or medical records. In another version, the identification device is packaged as a wearable personal accessory. The personal accessory may be at least one of;
a necklace,
a bracelet,
a ring,
a watch,
a belt buckle,
ID card,
glasses; or,
a pen/pencil.
   In another embodiment, the identification device may be implanted in the individual.

In a version, the identification device consists of identification data stored in media, the types if which may include;
bar code,
RFID,
memory, such as Flash, ROM, or non-volatile RAM,
magnetic, such as magnetic strip or electronic disk; or,
optical, such CD/DVD technology. The retrieval and display device includes interfaces to one or more of the media.

In an embodiment, the retrieval and display device is operated by service providers, and in a preferred embodiment the service providers are emergency medical operations. In versions of these embodiments, the retrieval and display device may be an intelligent data processor type which may be one of;
a PDA,
a personal computer; or
a smart terminal.

For the above embodiments, the communication paths may include at least one of;
Landline telephone service,
cellular telephone service,
satellite telephone service; or,
dedicated wireless network.

In another embodiment, the invention is a system for providing information about subscribers of an information service. The system includes a data base containing private information consensually provided by the subscribers and a physical identification and information storage device carried by a subscriber, identifying the subscriber and containing subscriber information. The subscriber updates information from the data base to the storage device. In a preferred version of this embodiment, the subscriber data is medical or medical related. In versions of the embodiment, the identification and storage device is a wearable accessory or implanted as described above.

### BRIEF DESCRIPTION OF THE DRAWINGS

The invention will be better understood by referring to the following figures.

FIG. 1 shows the general operation of the invention

FIG. 2 shows one embodiment of the invention

FIG. 3 shows another embodiment of the invention

### DETAILED DESCRIPTION OF THE INVENTION

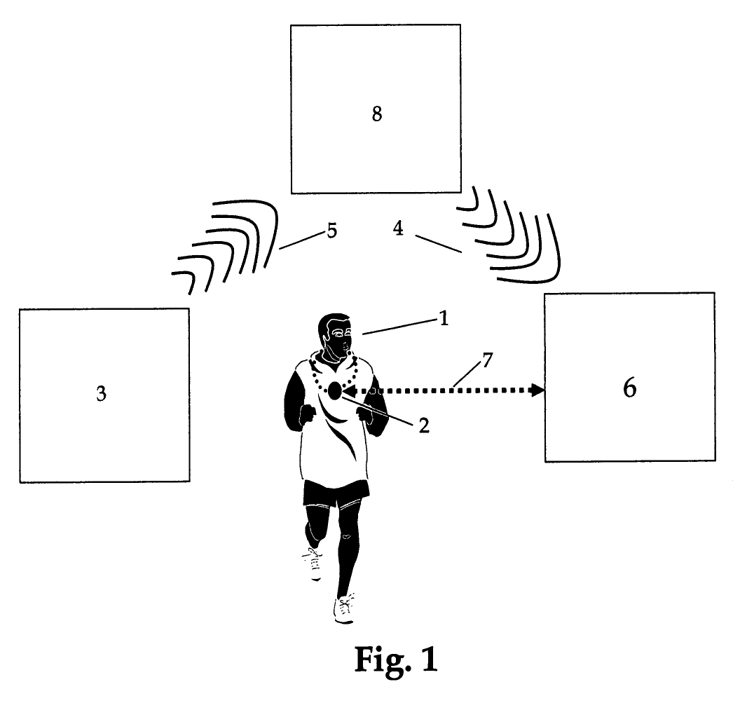

A preferred embodiment of the invention is illustrated in FIG. 1. An individual, 1, has personal information which he may want to be made available to service providers, particularly when the individual is traveling, and the need for the information is of an emergency nature. Although not limiting, the particular case which led to the conception of the invention is that of a person traveling who engages in activities, such as extreme sports, which have a significant risk of injury. Therefore it is of great benefit if such an individual carries with them at all times provision to either provide or make quickly available medical information in the event of an emergency away from home. Other uses of the system described herein will suggest themselves to skilled practitioners. The medical information example will be used as both an exemplary case, and as a preferred embodiment.

Individual 1 will typically subscribe to a service, which maintains a database of pertinent information about it's subscribers. Individual subscribers will carry an identification device shown at 2. In the operation of this embodiment, Device 2 supports a data path 7 to an information retrieval and display device 6. Upon accessing the identification data in 2, the retrieval device 6 through communication path 4 contacts database 3. In the most general case, one communication path 4 connects device 6 with a communications router 8, which in turn connects to database 3 through communications path 5.

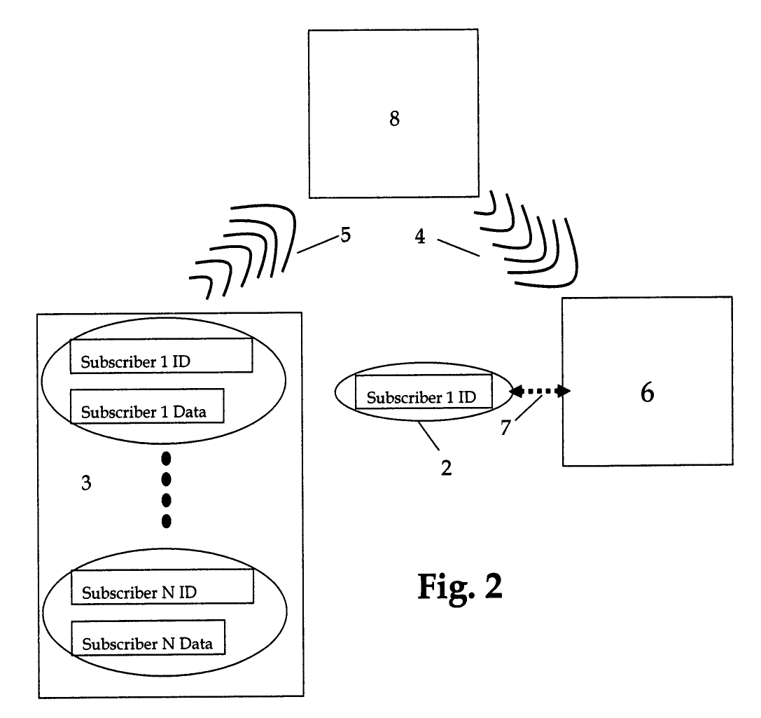

As shown in FIG. 2, Database 3 associates subscriber information with a subscriber ID. The subscriber ID for an individual matches the subscriber ID carried by the individual in device 2. Thus a service provider in possession of a suitable or compatible retrieval device 6, upon reading the subscriber ID from 2, may access the subscriber information. In the medical example, this information could include medical history and medical data, as well as medical insurance and treatment authorization. Depending on the nature of the communication paths and device types, such a system could allow for quick data transfer and treatment/insurance authorization in situations ranging from getting lab work done at a local clinic for a check-up to emergency treatment of a mountain climbing injury in Chile, all enabled by the information carried in Device 2.

Many different device types and communication paths will work within the scope of the invention. Typically database 3 would reside in a system provider's facility or facilities. It is envisioned that such fixed sites would be located in areas where communication path 5 would be convenient and fast. On the other hand, retrieval device 6 may be used in an area where communication options are limited. Therefore a communications router function 8 has to be able to receive communications from a variety of sources, and route the information from and to database 3. Therefore, routing block 8 must be able to receive on path 4, for example; landline communication from worldwide sources, cellular communication from worldwide sources, and satellite telephone communications. It is anticipated, although not strictly required, that database 3 will communicate on a high speed network connection to router 8. It is possible that database 3 and router 8 could be combined into one unit or device, but the variety of communication channels 4 that must be supported by 8 typically will preclude such a combination.

In order to make identification device 2 convenient enough that it always will be carried, a particularly useful packaging of 2 is as a personal accessory. Possible accessories include bracelets, watches, necklaces, rings, glasses, belt buckles, add-ons to ID cards such as driver's licenses, or pen/pencils. Other possible packaging options will suggest themselves to a skilled practitioner and are within the scope of the invention. It is also possible to implant the identification device, thus ensuring that the subscriber always carries the device. Possible media for storage of subscriber ID include; bar code, RFID, memory, such as Flash, ROM, or non-volatile RAM, magnetic, such as magnetic strip or electronic disk; or, optical, such CD/DVD technology. It can be seen that various combinations of these media and the above mentioned accessories or implantable implementations are technically possible and well within the capability of current state of the art media and medical packaging design.

Thus a retrieval device 6 must support an interface 7 to media such as named above, and at least one system supportable communication path 4. For a clinic in the individual's home area, the path 4 could be normal telephone, while for emergency medical personnel in Kenya, for example, the path 4 could be satellite telephone. Thus device 6 can be a variety of types depending on location, ranging from an office PC to a wireless PDA or notebook computer to a built-special smart terminal combination of satellite telephone, media reader, and display. Moreover device 6 could be a combination of separate media reading units, processing and display units, and communication units, not necessarily packaged together.

The inventors believe the utility of such a system is so powerful that adoption will be worldwide, allowing for a standardization of media and media interface. Thus after adoption, emergency personnel worldwide will carry a compatible retrieval device 6, most likely also including authorization protocol to prevent record access by non-approved individuals. Such a system used cooperatively by both healthcare providers and insurance providers is flexible, fast and secure, and will always be updated. However, before universal adoption takes place or if, for whatever reason, adoption is not universal, an alternative embodiment can also have utility.

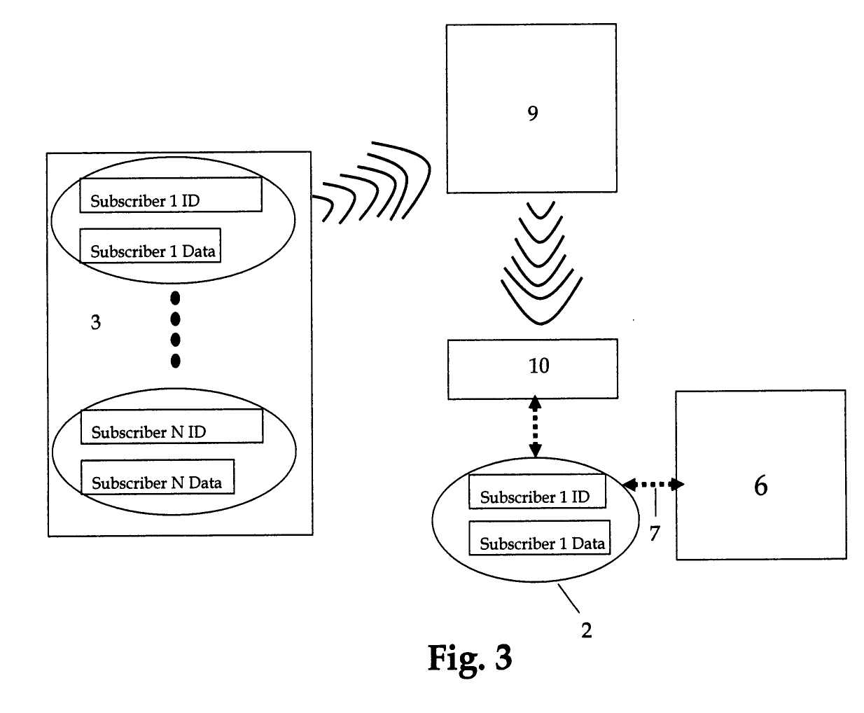

The alternative embodiment is illustrated in FIG. 3. In this embodiment, there is no communication between retrieval device 6 and the database. This embodiment relies on use of identification device 2 to store not only ID information but also the relevant data as well. Several of the media types mentioned above, as well as others, are capable of sufficient storage capacity, even when packaged as a personal accessory or implant. In this embodiment, the ID device 2 will have to be initialized and periodically updated. Typically, it is envisioned that the device 2 will be interfaced to the subscriber's PC 10, which will communicate, possibly through an interface 9, or directly, with database 3. Other interfaces at 10 are possible such as a PDA, cell phone etc as well as others which will occur to practitioners. Thus it becomes the responsibility of the subscriber to ensure that the information carried with him is correct. Depending on the media type use in 2, device 6 could be generic. For instance, media 2 could have a USB interface and look like peripheral memory. In which case almost any laptop or PC anywhere in the world could access the information. Thus it would be possible for the subscriber to carry medical and insurance data, and have many service providers capable of accessing the data with standard, commonly available devices.

Thus a universal information retrieval system, particularly suitable to medical information has been disclosed. Obviously variants and other applications will suggest themselves to skilled practitioners. The examples presented are not meant to be limiting in any way. The scope of the invention is defined only by the following claims.

We claim:

1. A system for providing information about subscribers of an information service, comprising;
a data base containing private information consensually provided by the subscribers,
a physical identification device carried by a subscriber, identifying the subscriber,
an information retrieval and display device,
at least one communication path between the data base and the retrieval and display device, wherein;
identification data from the identification device is presented to the retrieval and display device, allowing the retrieval and display device to access the database through the communication path and retrieve information about the subscriber identified by the identification device.

2. The system of claim 1 wherein the information includes at least one of medical data, medical history, medical insurance information, treatment authorizations, or medical records.

3. The system of claim 1 wherein the identification device is packaged as a wearable personal accessory.

4. The system of claim 1 wherein the identification device is packaged as a medical implant.

5. The system of claim 3 wherein the personal accessory is at least one of;
a necklace,
a bracelet,
a ring,
a watch,
a belt buckle,
ID card,
glasses; or,
a pen/pencil.

6. The system of claim 1 wherein the identification device consists of identification data stored in media, the types if which may include;
bar code,
RFID,
memory, such as Flash, ROM, or non-volatile RAM,
magnetic, such as magnetic strip or electronic disk; or,
optical, such CD/DVD technology; wherein the retrieval and display device includes interfaces to one or more of the media.

7. The system of claim 1 wherein the retrieval and display device is operated by service providers.

8. The system of claim 7 wherein the service providers are emergency medical operations.

9. The system of claim 1 wherein the retrieval and display device may be an intelligent data processor type which may be one of;
a PDA,
a personal computer; or
a smart terminal.

10. The system of claim 1 wherein the communication paths may include at least one of;
landline telephone service,
cellular telephone service,
satellite telephone service; or,
dedicated wireless network.

11. A system for providing information about subscribers of an information service, comprising;
a data base containing private information consensually provided by the subscribers; and,
a physical identification and information storage device carried by a subscriber, identifying the subscriber and
containing subscriber information, wherein;
the subscriber updates information from the data base to the storage device.

12. The system of claim 11 wherein the information includes at least one of medical data, medical history, or medical records.

13. The system of claim 11 wherein the identification device is packaged as a wearable personal accessory.

14. The system of claim 11 wherein the identification device is packaged as a medical implant.

15. The system of claim 13 wherein the personal accessory is at least one of;
a necklace,
a bracelet,
a ring,
a watch,
a belt buckle,
ID card,
glasses; or,
a pen/pencil.

16. The system of claim 11 wherein the identification device consists of identification data stored in media, the types if which may include;
bar code,
RFID,
memory, such as Flash, ROM, or non-volatile RAM,
magnetic, such as magnetic strip or electronic disk; or,
optical, such CD/DVD technology.
